(19) United States
(12) Patent Application Publication
(10) Pub. No.: US 2005/0075944 A1
(43) Pub. Date: Apr. 7, 2005

(54) Design order receiving system

(75) Inventors: Shinji Murata, Tokyo (JP); Tsuyoshi Narumiya, Tokyo (JP); Yuichi Marikawa, Tokyo (JP); Reiko Yamauchi, Tokyo (JP); Toshiya Sato, Tokyo (JP)

Correspondence Address: Finnegan, Henderson, Farabow,;Garrett & Dunner, L.L.P., 1300 I Street, N.W., Washington, DC, 20005-3315, US

(73) Assignee: KONICA MINOLTA PHOTO IMAGING, INC.

(21) Appl. No.: 10/949,454

(22) Filed: Sep. 27, 2004

(30) Foreign Application Priority Data
Oct. 1, 2003 (JP) JP2003-342850

(51) Int. Cl. G06F 17/60

(52) U.S. Cl. 705/26

(57) ABSTRACT

A design ordering system including a user terminal which is connected to a network and is for ordering designs; an order server which is connected to the network and is for managing receipt of the design orders; an order manager terminal which is connected to the network, and is for placing orders for the design creation work based on the design order; a worker terminal which is connected to the network and is for creating designs based on the orders placed for the design creation work; a corrector terminal for correcting the created design, wherein the order server has a common screen which is accessible from the user terminal; the order manager terminal; the worker terminal and the corrector terminal.

### TECHNICAL FIELD

The present invention relates to a design ordering system for providing the user (customer) with a service for creating designs for postcards and the like which have pictures via a network such as the internet.

### BACKGROUND

In recent years, many users (customers) have been sending wedding greetings, new-year greetings and the like by postcards with photo images. Also, business cards and the like that have photo images are becoming popular. Network businesses have been proposed, in which order for creating these postcards or business cards with photo images is done via the internet (For example, Japanese Patent Publication Open to Public Inspection No. 2001-344313 and Japanese Patent Publication Open to Public Inspection No. 2003-8872).

In this case, when the postcard is being ordered, the user (customer) may, for example, select a set layout for the postcard design, or may decide on an individually selected layout for the position of the photo image or the text information. The text information to be input may include user address, name, and the greetings.

At output centers that provide image printing services based on design orders from these users (customers), orders for creating the designs are placed with the workers who do designing and the like, and when design creation is complete, the design is checked against the design order received from the user (customer). This is then printed out and sent to the user (customer).

At output centers that provide image printing services, design orders are distributed among the workers such as designers, but there are cases where the photo image uploaded by the user cannot be used because it is unclear or cases where the design cannot be done in the way that the user desires. Also, sometimes the user wishes to be informed of the progress status of the design work, and in this case it is preferable for communication between the user and order manager to be possible.

Meanwhile, communication regarding the design work and daily schedules and the like are sent between the order manager which manages receipt of the design orders and places the orders for the design creation work, and the worker terminal which performs the design work. Also, in the case where a corrector who is different from the order manager corrects the created design, communication is sent regarding the items for correction and the like. When correction of the created design is necessary, there is also communication between the manager and the corrector regarding the items for editing.

In this manner, the user, the manager, the worker and the corrector communicate with regard to the design creation, but contact is not possible by phone when the party being contacted is away. Also it was not possible by telephone or facsimile, to accurately relate for example, the portion of the image that is unclear or the manner in which it is unclear. Also, the location for editing on the image that has been created could not be accurately communicated.

### SUMMARY

This invention was conceived in view of these problems, and an object thereof is to provide a design ordering system in which design creation, correction and the like can be performed speedily and accurately.

This invention solves the above-described problems and achieves the objects by being configured as described in the following.

A design ordering system comprising: a user terminal which is connected to the network and is for ordering designs; an order server which is connected to the network and is for managing receipt of the design orders; an order manager terminal which is connected to the network, and is for placing orders for the design creation work based on the design order; and a worker terminal which is connected to the network and is for creating designs based on the orders placed for the design creation work; a corrector terminal for correcting the created design, wherein the order server has a common screen which is accessible from the user terminal, the order manager terminal, the worker terminal and the corrector terminal.

Also, the order manager terminal forms the corrector terminal.

The common screen of the present invention has at least design order information and communication information.

In addition, the common screen of this invention has communication information which is only displayed on the manager terminal and the worker terminal and is not displayed on the user terminal.

The common screen of this invention has an upload screen for displaying the created design.

The common screen of this invention also has editing history information for the created design.

The present invention has the following effects.

Because the order server has a common screen which is accessible from the user terminal, the order manager terminal, the worker terminal and the corrector terminal, the user, the order manager, the worker and the corrector can all share information that changes regardless of location and time on the common screen of the order server, and thus design creation and correction can be performed speedily and accurately.

Because the order manager terminal forms the corrector terminal, the order manager may function as the corrector.

Because the common screen includes at least design order information and communication information to be passed between the user and the manager, by accurately passing on information that changes regardless of location and time at any time, design creation and correction can be performed speedily and accurately.

In addition, the common screen has communication information which is only displayed on the manager terminal and the worker terminal and is not displayed on the user terminal, and unnecessary information is not passed to the user, and thus it is possible to perform design creation and correction speedily and accurately.

Because the common screen displays the created design, designs can be corrected speedily and accurately.

Because the common screen has editing history information for the created design screens, design creation and correction can be performed speedily and accurately without waste.

### BRIEF DESCRIPTION OF THE DRAWINGS

FIG. 1 shows the print order system and print order method.

FIG. 2(a) is a flowchart of design ordering.

FIG. 2(b) is a flowchart of design confirmation and print ordering.

FIG. 3 shows the design selection screen in the case where the New Year category has been selected.

FIG. 4 shows the selected design template.

FIG. 5 shows the order information input screen.

FIG. 6(a) shows inputting of zodiac sign and date of birth.

FIG. 6(b) shows inputting of zodiac sign and date of birth.

FIG. 7 shows the image upload screen.

FIG. 8 shows the design content confirmation screen.

FIG. 9 shows the credit card information input screen.

FIG. 10 shows the postcard type/quantity input screen.

FIG. 11 shows the print order charge confirmation screen.

FIG. 12 shows the receiving/payment method selection screen.

FIG. 13 shows the shop selection screen.

FIG. 14 shows the address/credit card information input screen.

FIG. 15 shows the print order final confirmation screen.

FIG. 16 shows the design order complete screen.

FIG. 17 shows the design order information screen.

FIG. 18 shows the print order final confirmation screen.

FIG. 19 shows the postcard type/quantity input screen.

FIG. 20 shows the print order charge confirmation screen.

FIG. 21 shows the receiving/payment method selection.

FIG. 22 shows inputting at the common screen.

FIG. 23 shows the common screen for management displayed at the order manager terminal.

FIG. 24 shows the common screen displayed at the worker terminal.

FIG. 25 shows the common screen for correction displayed at the order manager terminal.

FIG. 26 shows the common screen displayed at the user terminal.

FIG. 27 is a flowchart of the design creation status of the design ordering system.

### PREFERRED EMBODIMENTS OF THE INVENTION

The following describes embodiments of the design ordering system of this invention, but this invention is not to be limited by these embodiments. Also this embodiment of the invention is the most preferred embodiment of the invention, and the terminology of the invention is not limited to that of this embodiment.

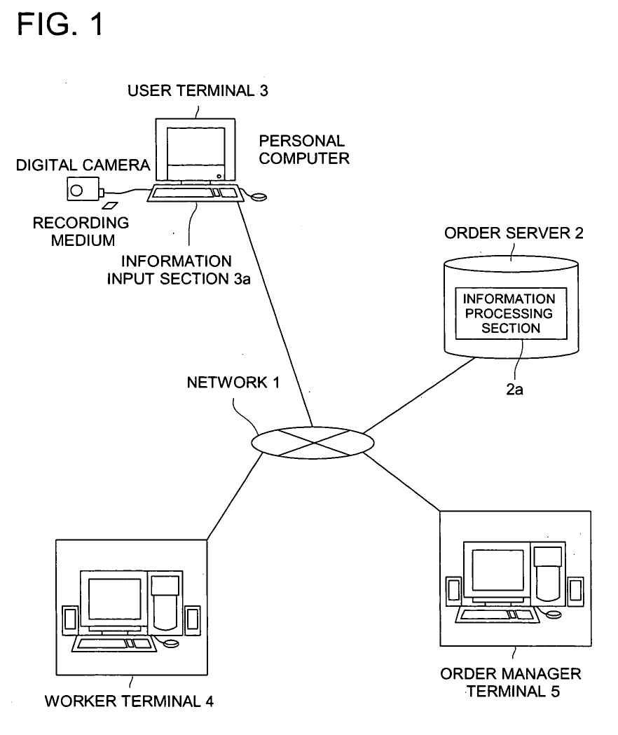

FIG. 1 shows the design ordering system. In FIG. 1 the order server 2, the user terminal 3, the worker terminal 4, and the order manager terminal 5 are connected to the network 1 and each of these may communicate via the network 1.

The network 1 is a network in which a computer system, terminals and data communication devices are connected to each other. The network may be connected by wire such as by dedicated lines, public lines, or may be connected wirelessly by communication satellite or the like. The network may also be connected by a combination of both. That it to say, examples of the network include the internet and the like.

The order server 2 receives design orders, places orders for the design creation work based on the design orders, and does order management via network 1, and also provides the network image services of listing the images for use in the design, storing the images, managing customer information and the like.

The user terminal 3 may be any electronic device terminal that is capable of sending and receiving text and image information such as a personal computer, a personal digital assistant (PDA) or a mobile phone. In the case of a personal computer or personal digital assistant (PDA), the user terminal may be connected to a digital camera, and a recording medium on which an image has been recorded may be set in the digital camera so that an image can be uploaded. The image may also be uploaded from a scanner or the like. For a mobile phone that is equipped with a digital camera, the image may be obtained by taking pictures with the digital camera, and for a mobile telephone that is not equipped with a digital camera the image may be obtained by being sent from another electronic device.

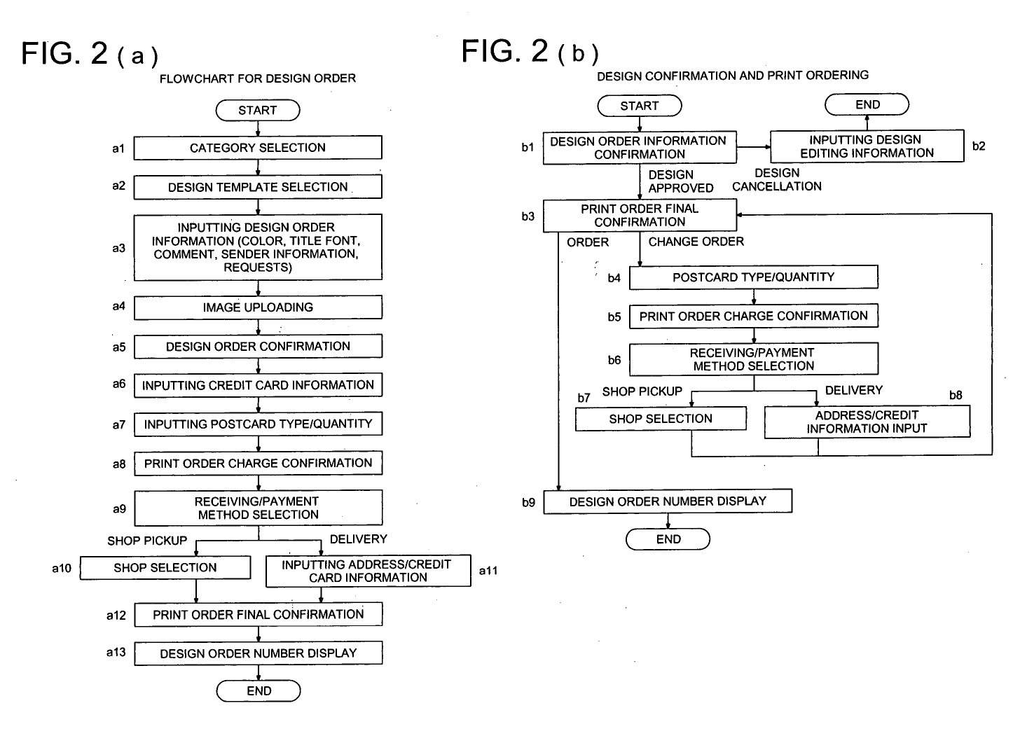

At the user terminal 3, design determining information is input, the images for use in the design are uploaded, and inputting of design order information and inputting of print order information are done consecutively. The design ordering and the print ordering are shown in FIG. 2 to FIG. 21.

The order manager terminal 5 is disposed in a lab or the like, and can receive print orders and manage the print creation work via the order server 2. The order manager terminal 5 is connected to an output device such as a printer, and prints based on the print order information input at the user terminal 3.

The worker terminal 4 is for receiving design orders via the server 2; performing the design creation work based on the design order information at the image editing screen, and for performing operations such as image cutting, color information correction, text information input, layout, and deletion of unnecessary parts. The created design may be sent from the worker terminal 4 to the order server 2.

In order to input design order information in this embodiment, user selects a design template which has pre-stored template information which can be changed by at least input information. The design templates are prepared in advance at the order server 2 for each category (wedding, birthday, moving and the like). Information to be displayed at the design template is input by an information inputting section 3a such as a keyboard of the user terminal 3. The information processing section 2a of the order server 2 processes the input information in accordance with the template information and the design ordering is thereby performed.

The information processing section 2a performs the process of converting the input language to another language. For example, if the user inputs information in Japanese, conversion to English can be performed without any errors and operation characteristics are thereby improved. Also, the process of converting the input information to related information may be performed. For example the user may input date of birth and this is converted to zodiac sign, age, or animal sign of the Japanese zodiac without error, and thus operation characteristics are improved.

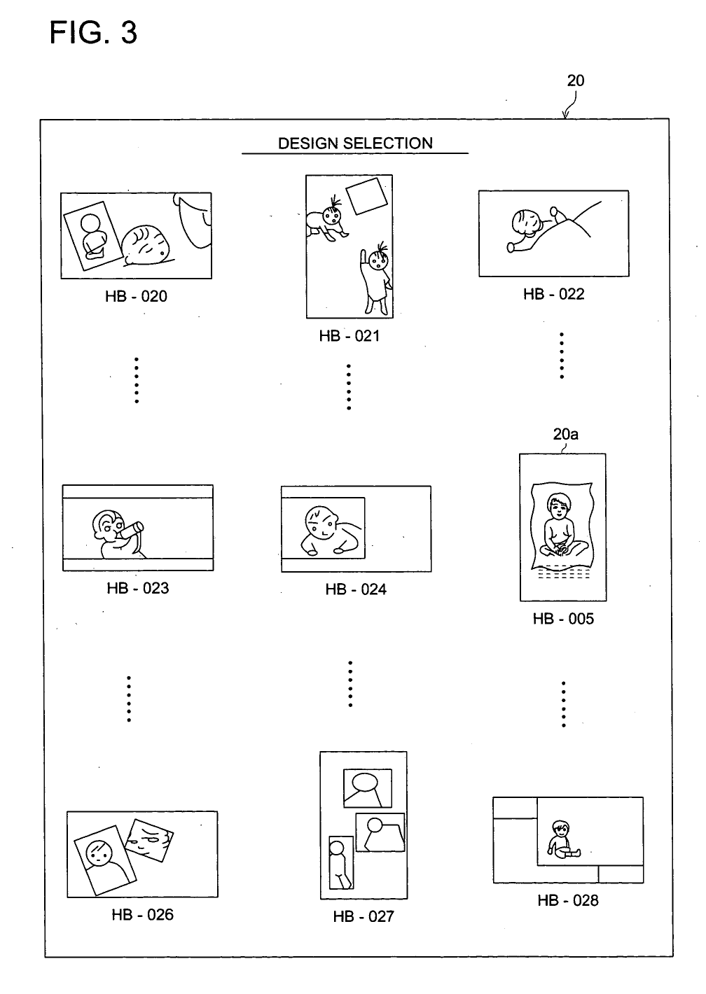

The flow of the design ordering performed using the user terminal 3 is shown in FIG. 2, and screens from the user terminal 3 at which this design ordering is performed are shown in FIG. 3 to FIG. 21.

The flow of design ordering is shown in FIG. 2(a).

[Step a1]

First, when the design is ordered, the category is selected from among New Year, wedding, birthday, moving and the like. FIG. 3 shows the design selection screen 20 at which the New Year category has been selected. In this manner, a plurality of design templates 20a are prepared in advance for each category such as New Year, wedding, birthday, moving and the like.

[Step a2]

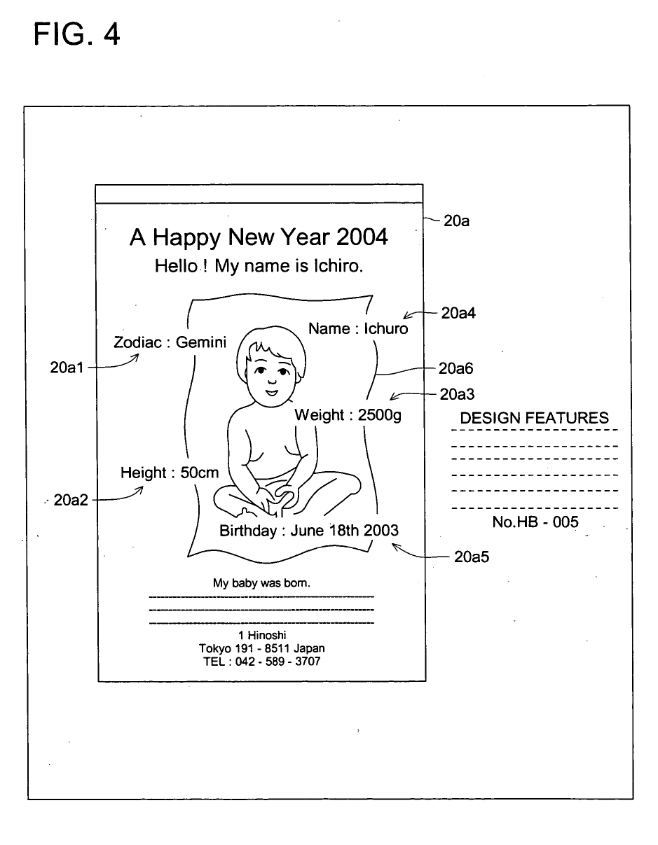

There is a plurality of design templates displayed at the design selection screen 20 shown in FIG. 3 in which the New Year category was selected, and a desired design template 20a is selected from this plurality of design templates. The selected design template 20a is shown in FIG. 4, and the design template 20a includes the template information 20a1˜20a5 and the image 20a6 which can be changed by input information. Template information 20a1 is the zodiac sign; template information 20a2 is the baby's height; template information 20a3 is the baby's weight; template information 20a4 is the baby's name (in roman letters); and template information 20a5 is the baby's birthday, all of which are designed in English.

[Step a3]

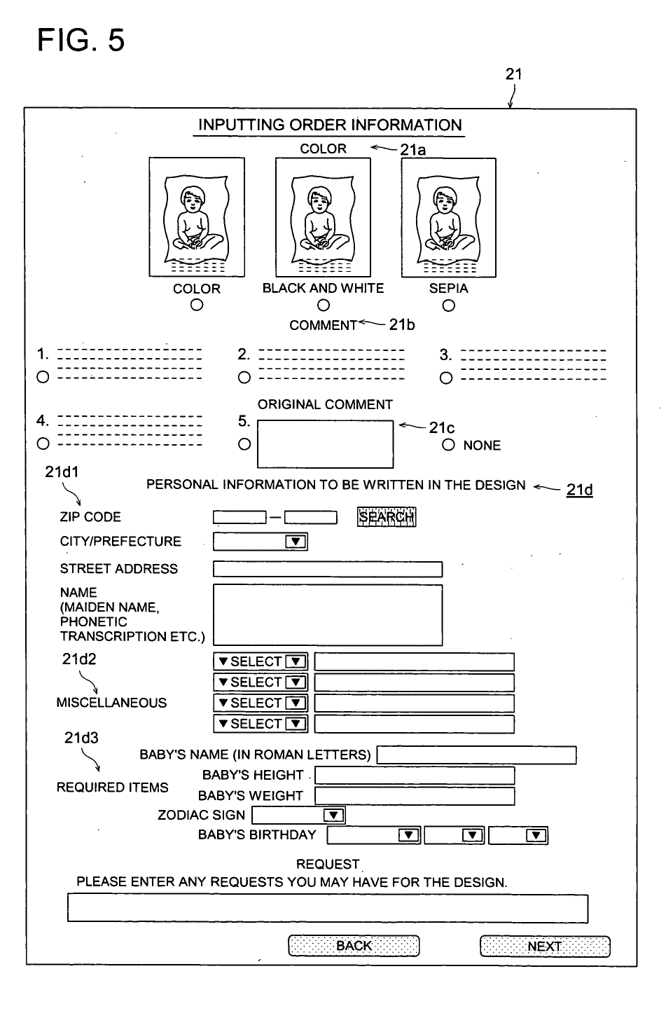

The design order information to be input in the selected design template is input at the order information input screen 21 in FIG. 5. The design order information comprises color 21a, title font 21b, original comments 21c, and personal information to be written in the design 21d. The personal information to be written in the design 21d comprises sender information 21d1, miscellaneous information 21d2, and required items 21d3. The required items 21d3 include baby's name (in roman letters), baby's height, baby's weight, zodiac sign, and baby's birthday, all of which are input in Japanese.

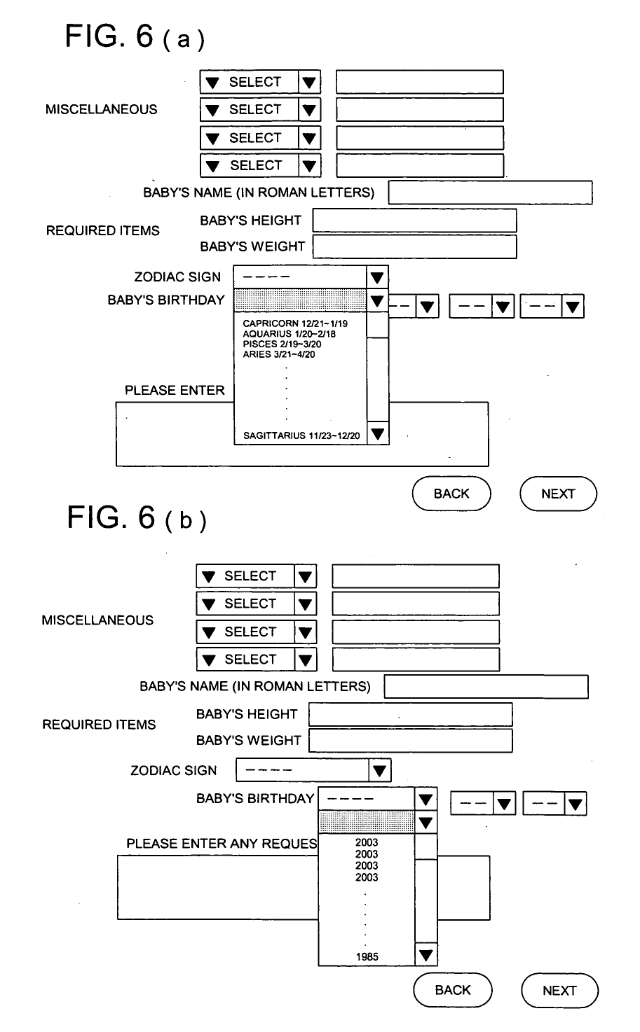

Inputting of the zodiac sign is done as shown in FIG. 6(a) by clicking zodiac sign and when the list of the zodiac signs are displayed by pull-down menu, and when the date of birth is selected, the applicable zodiac sign is input. Furthermore, inputting of the baby's birthday is done by clicking and displaying date of birth as shown in FIG. 6(b), and selecting and inputting the applicable year, month and day of birth.

The required items 21d3 which are the baby's name (in roman letters), baby's height, baby's weight, zodiac sign, and baby's birthday, and which were input in Japanese are converted to English in the design of the design template.

[Step a4]

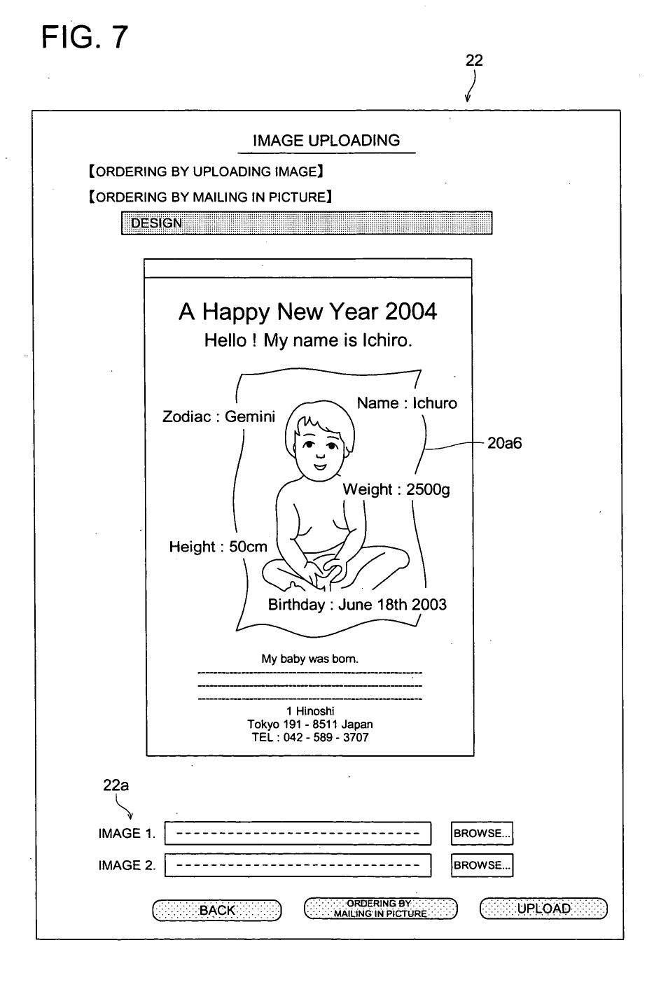

In the image upload screen 22 in FIG. 7, the image 22a to be input in the image 20a6 of selected design template is uploaded. The uploading of this image 22a is not performed using a prescribed file format, and in the case where an image is not uploaded, the order may be made by mailing in a picture. It is to be noted that the image frame in FIG. 7 displays only the necessary number of images for the selected design template.

[Step a5]

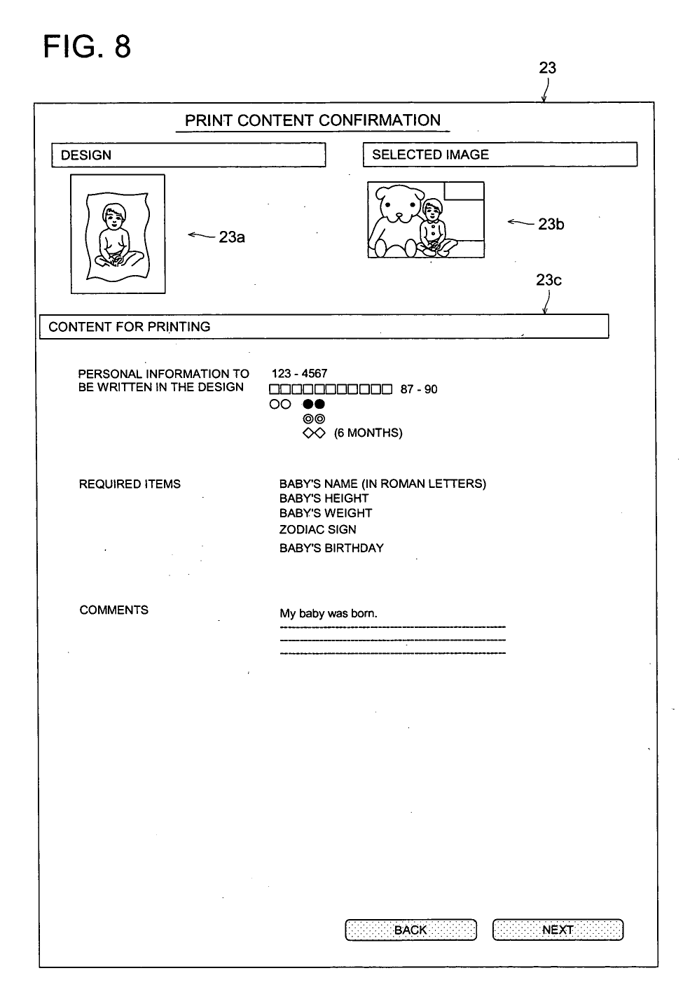

In the design content confirmation screen 23 of FIG. 8, the design order is confirmed by displaying the design 23a, the selected image 23b, and the content for printing 23c.

[Step a6]

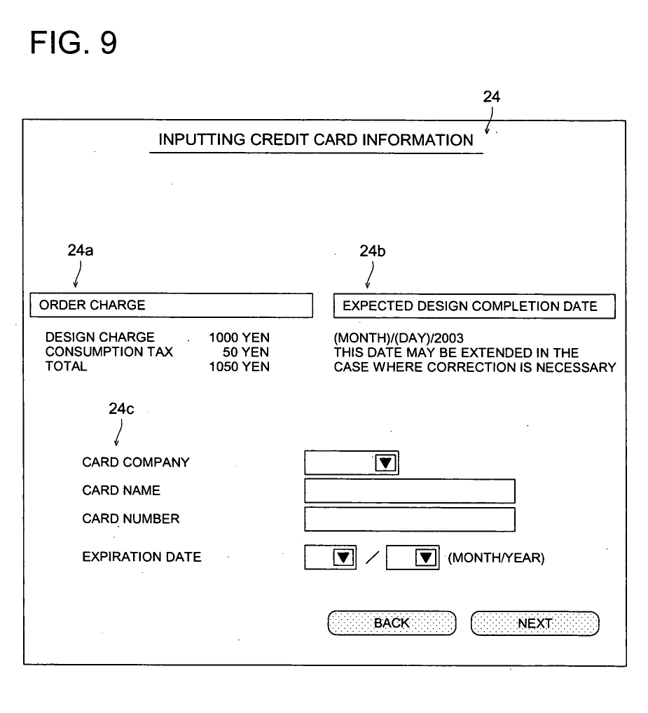

In the credit card information input screen 24 of FIG. 9, the design charge 24a and expected date of completion 24b are confirmed by being displayed, and the credit card information 24c is input. The payment of the design charge is done by credit card.

[Step a7]

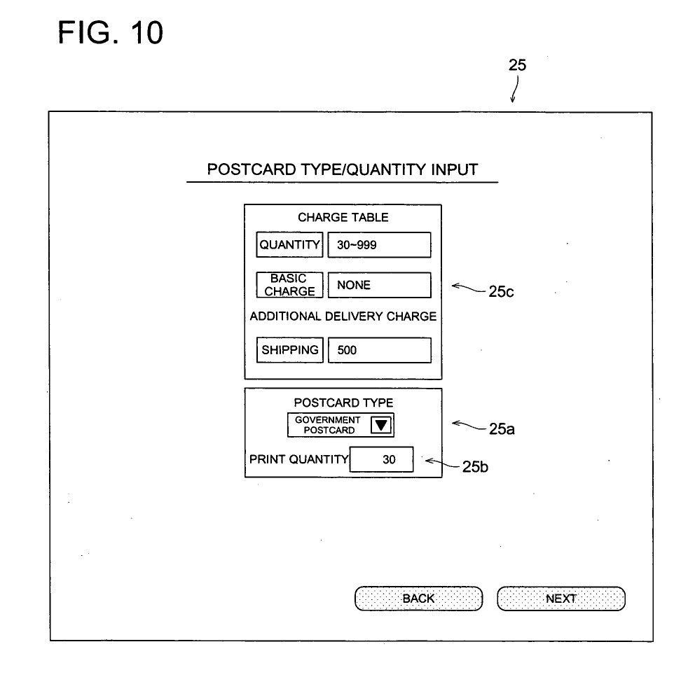

At the postcard type/quantity input screen 25 in FIG. 10, the postcard type 25a and quantity 25b are input, and the charge amount 25c is displayed as a result of the postcard type and quantity being input.

[Step a8]

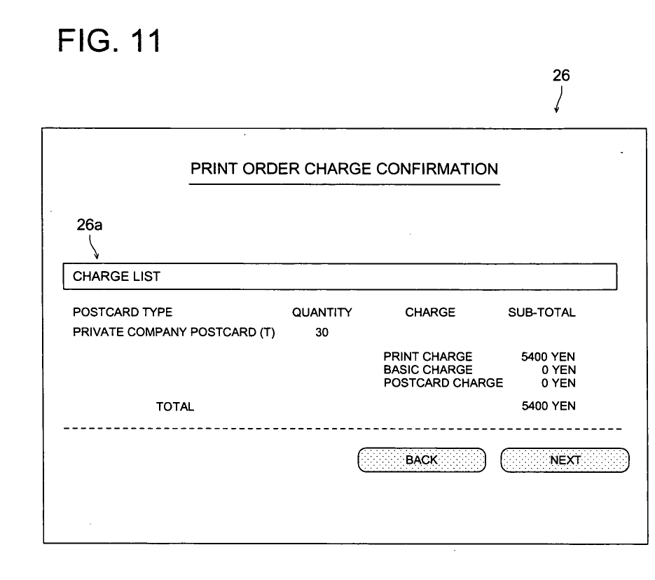

At the print order charge confirmation screen 26 in FIG. 11, the print charge list 26a is displayed, and the print order charge is confirmed.

[Step a9]

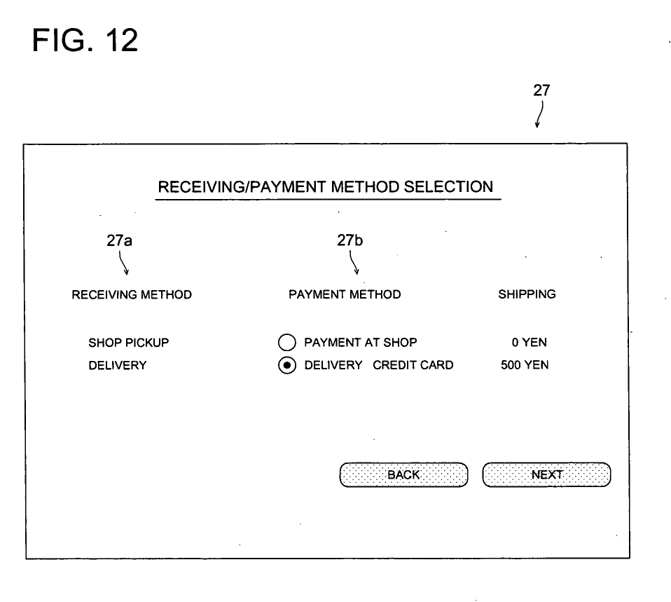

At the receiving/payment method selection screen 27 in FIG. 12, the receiving method 27a and the payment method 27b are selected. The receiving methods 27a include shop pickup and delivery, and the payment methods 27b include payment at the shop or by credit card.

[Step a10]

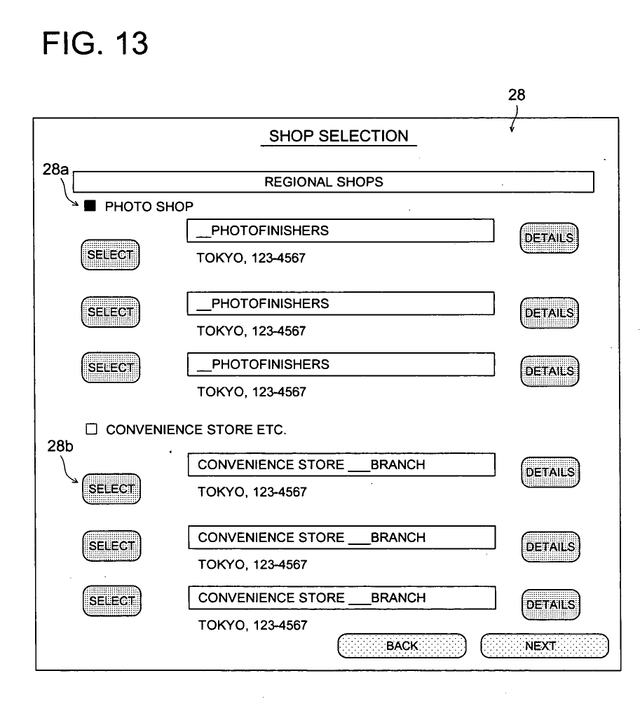

If shop pickup is selected as the receiving method 27a, a regional shop offering the service is selected from photo shop 28a or convenience store 28b at the shop selection screen 28 in FIG. 13.

[Step a11]

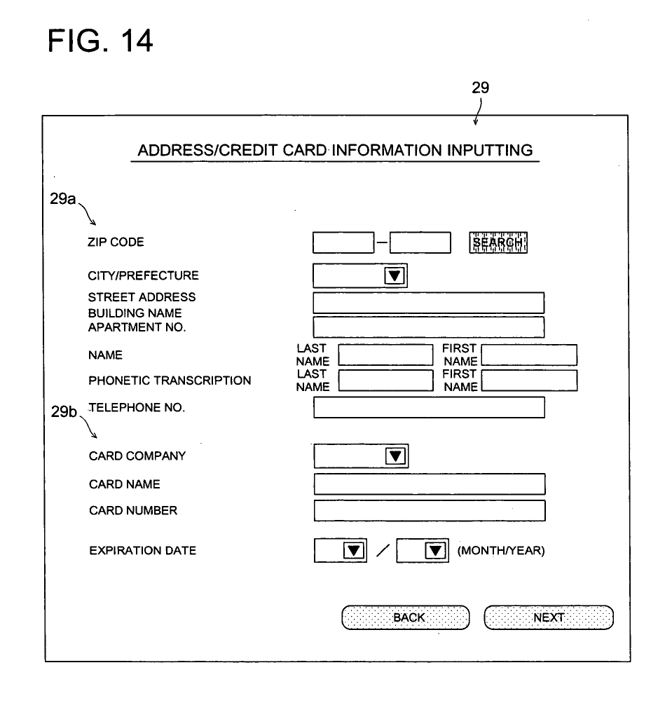

If delivery is selected as the receiving method 27a, the address 29a and the credit card information 29b are input in the address/credit card information input screen 29 in FIG. 14.

[Step a12]

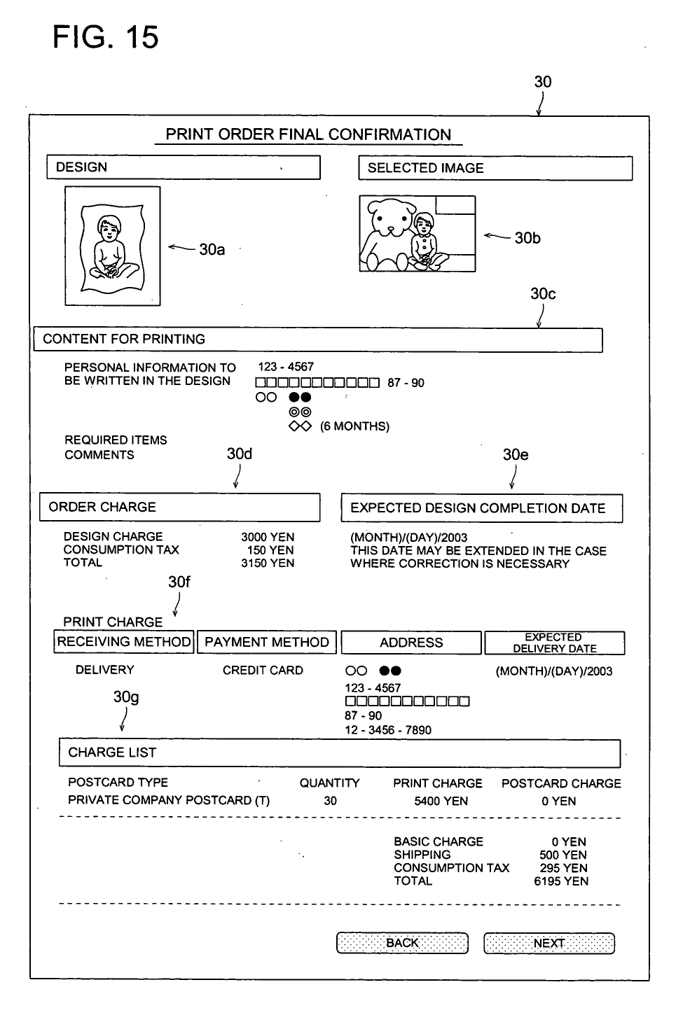

When shop selection is done or the address/credit card information is input, the design 30a, the selected image 30b, the content for printing 30c, the design charge 30d, the expected design completion date 30e, the print charge 30f (receiving method, payment method, address, expected delivery date) and charge list 30g are displayed at the print order final confirmation screen 30 in FIG. 15, and the final confirmation of the print order is thereby done.

[Step a13]

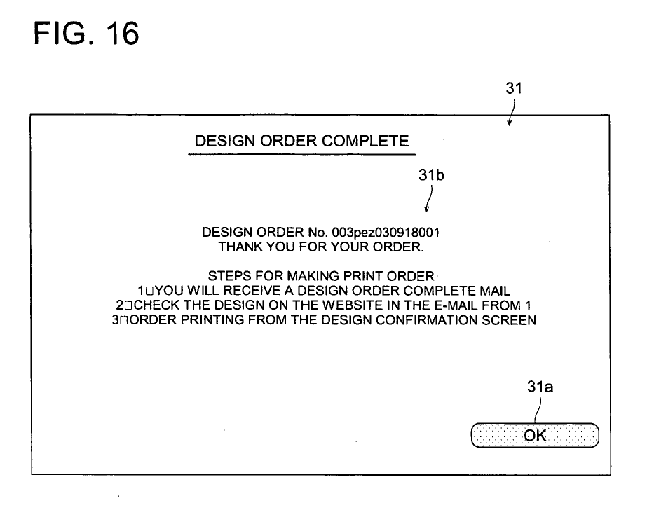

In the design order complete screen 31 in FIG. 16, the order number 31b is displayed, when the OK button 31 is clicked, and the design order is complete.

The flow of the design confirmation and print ordering is shown in FIG. 2(b).

[Step b1]

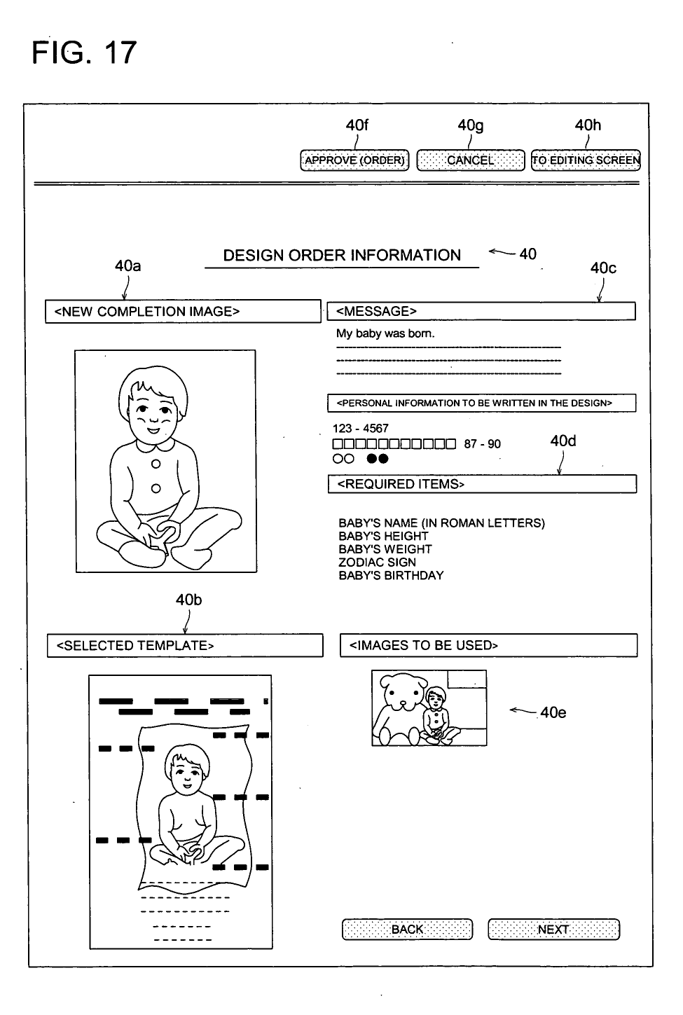

At the design order information screen 40 in FIG. 17, the most recently completed image 40a, the selected design template 40b, message 40c, and personal information written in the design 40d, image to be used 40e and the like are confirmed.

The design order information screen 40 has an order OK button 40f, a cancel button 40g and an editing screen button 40h. If there is a problem with the created design, the editing screen button 40h is clicked and the process goes to Step b2. When the order OK button 40f is clicked, the design is approved.

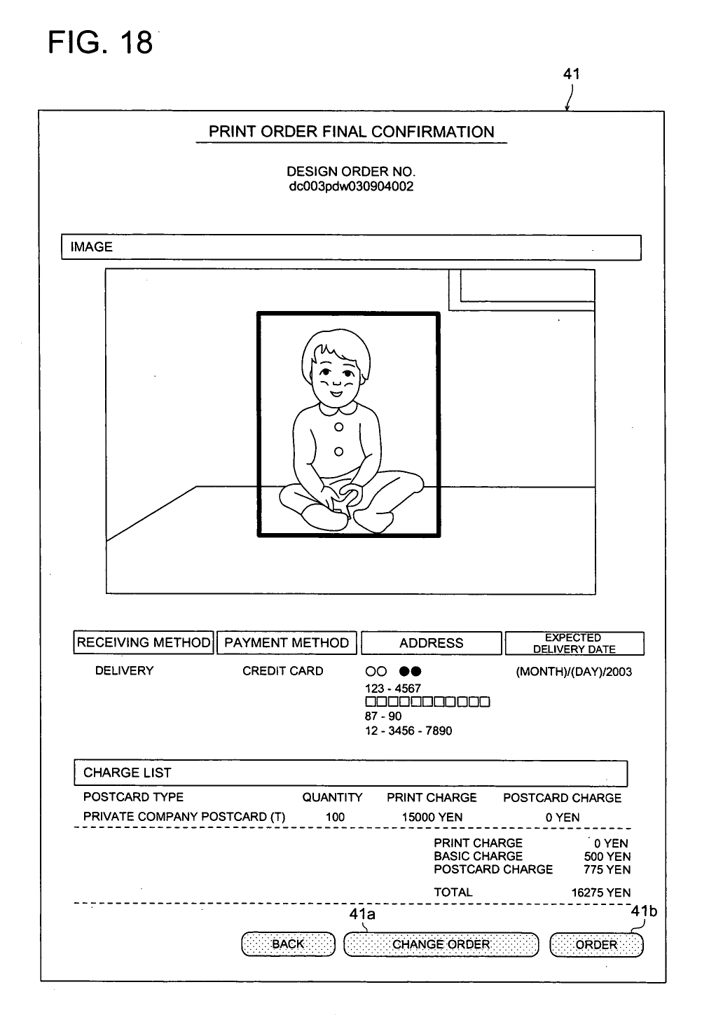

If the cancel button 40g is clicked, the print order final confirmation screen 41 of FIG. 18 is opened.

[Step b2]

If the editing screen button 40h is clicked, the editing screen (not shown) is opened, and design editing information is input.

[Step b3]

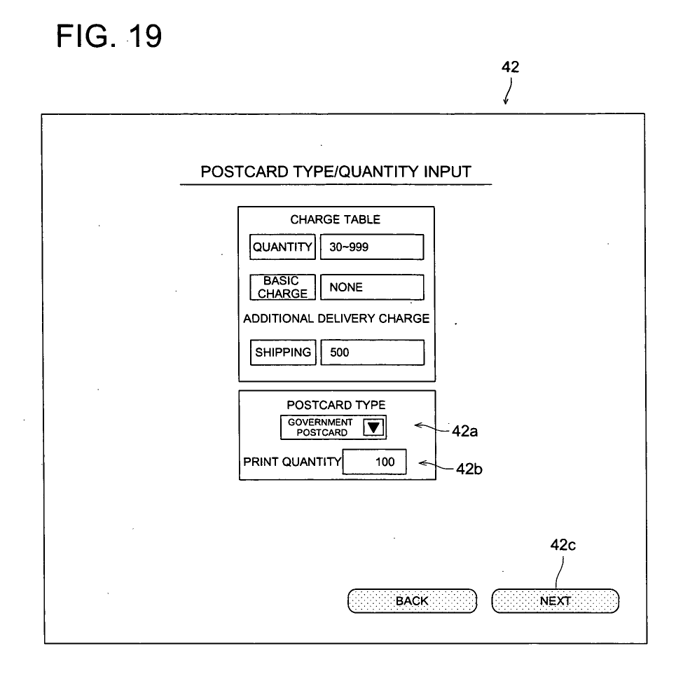

The print order final confirmation screen 41 of FIG. 18 has an order button 41a which can change the print order information. When this order changing button 41a is clicked, the postcard type/quantity input screen 42 in FIG. 19 is opened.

[Step b4]

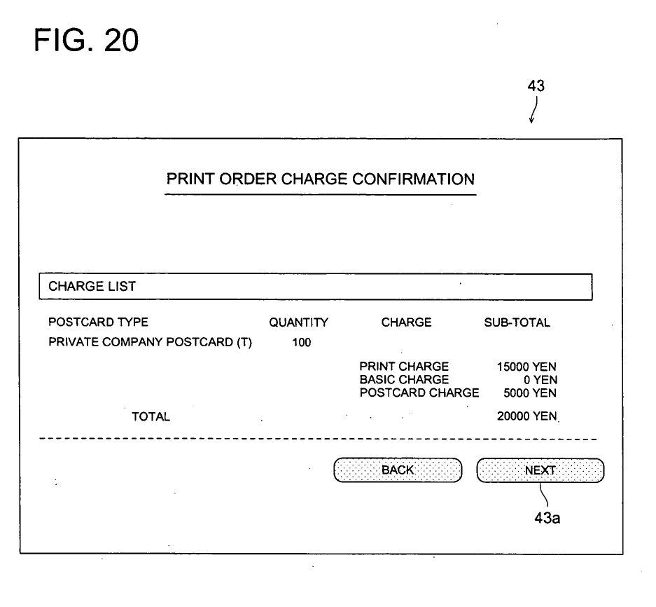

The postcard type 42a and the quantity 42b are input and changed at the postcard type/quantity input screen 42 in FIG. 19, and when the next button 42c is clicked, the print order charge confirmation 43 in FIG. 20 is opened.

[Step b5]

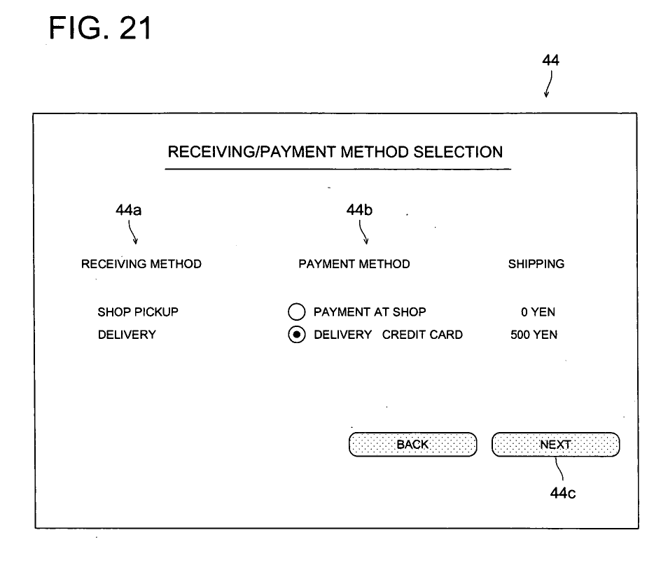

At the print order charge confirmation screen 43 in FIG. 20, the postcard type and quantity are confirmed, and if there are no problems, when the next button is clicked, the receiving/payment method selection screen 44 in FIG. 21 is opened.

[Step b6]

At the receiving/payment method selection screen 44 in FIG. 21, the receiving method 44a and the payment method 44b are selected.

[Step b7]

If shop pickup is selected as the receiving method 44a, the shop selection screen 28 of FIG. 13 is opened, and a photo shop or convenience store is selected.

[Step b8]

If delivery is selected as the receiving method 44a, the address/credit card information screen 29 of FIG. 14 is opened and address/credit card information is input. In addition, when the next button 44c is clicked, the process goes to step b3 and the print order final confirmation screen 41 in FIG. 18 is opened.

[Step b9]

When the order button 41b is clicked at the print order final confirmation screen 41 in FIG. 18, the print order number is clicked, the print order number is displayed and print ordering is complete.

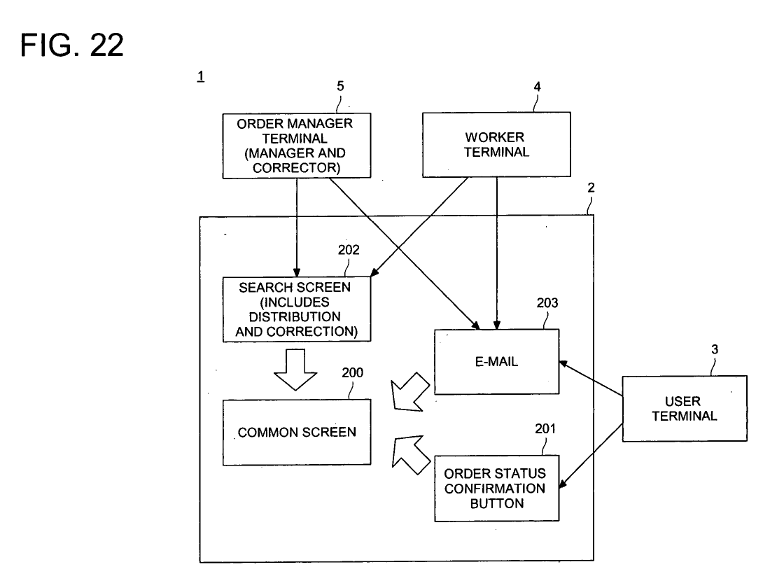

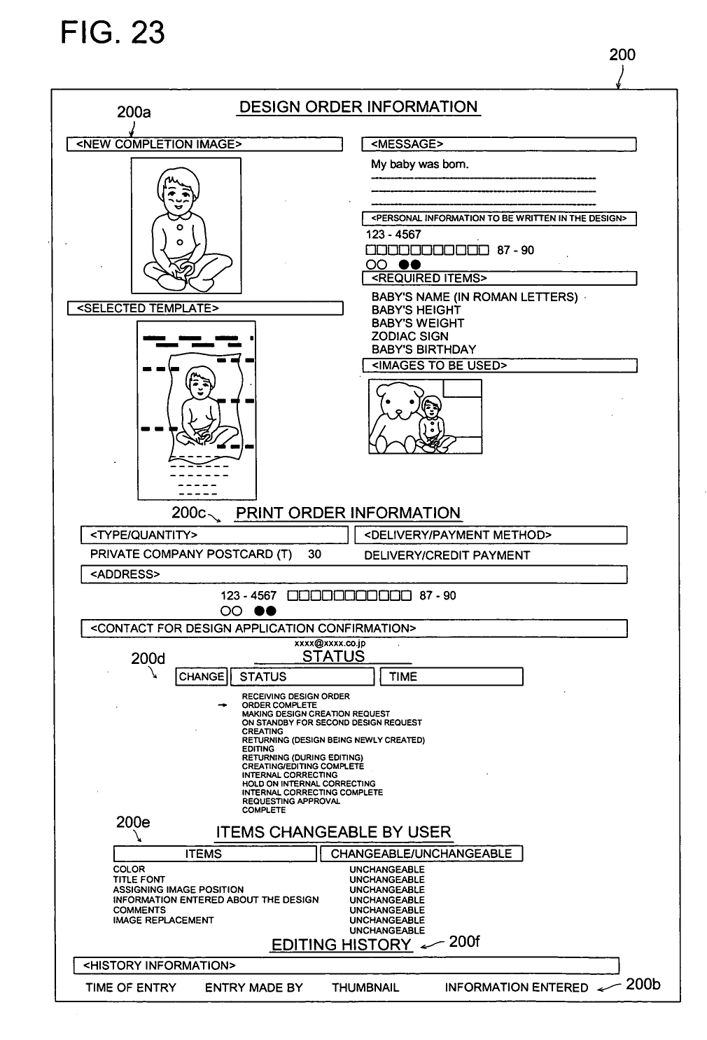

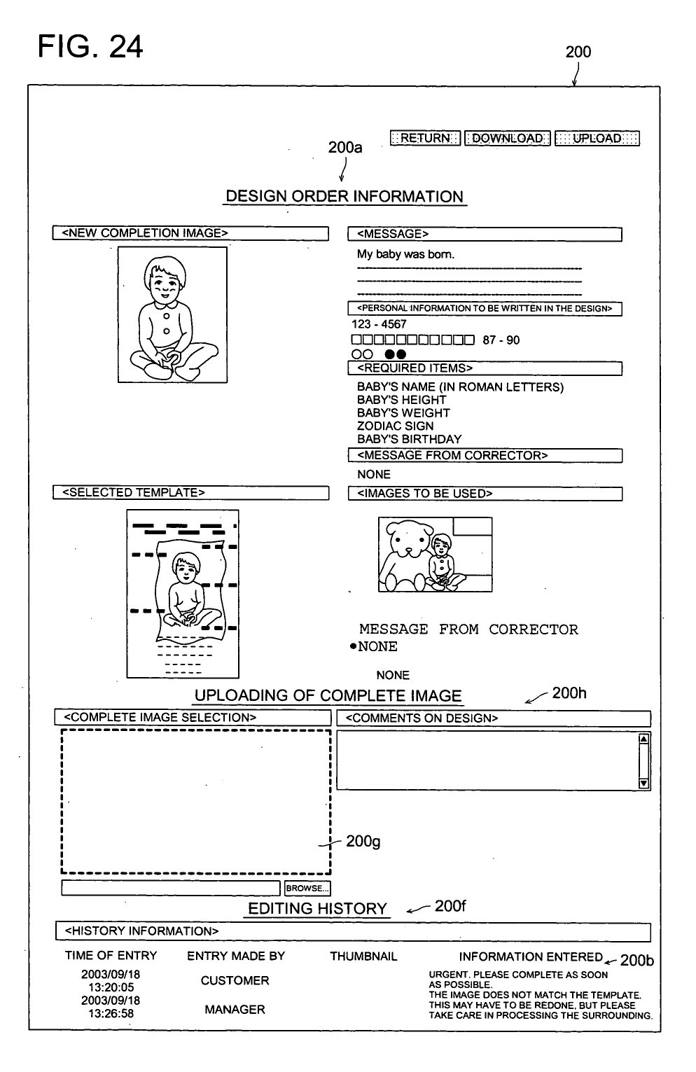

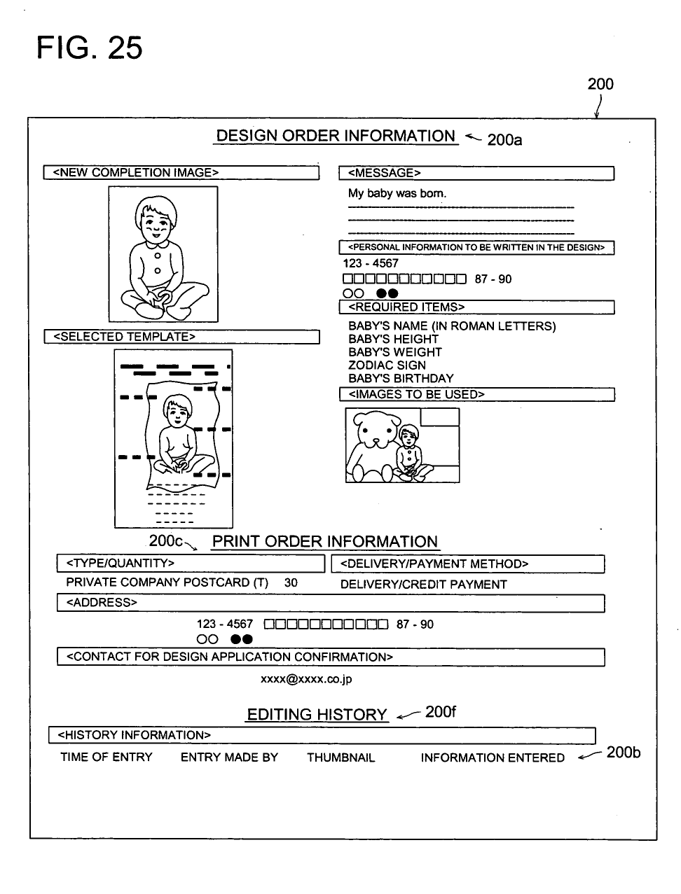

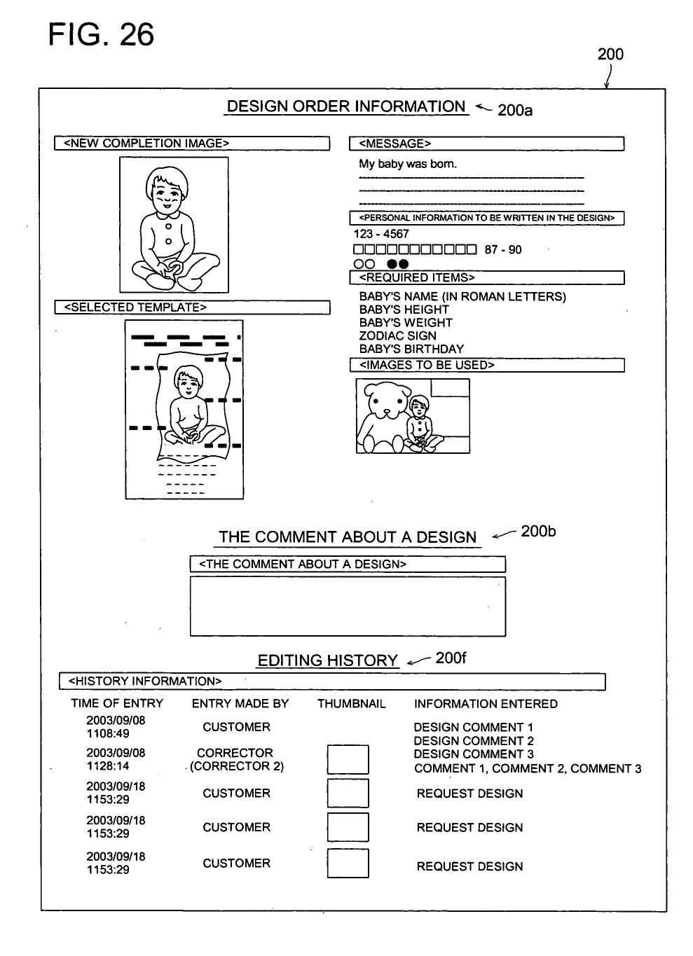

Next, an embodiment for creating a design based on the design order is shown in FIG. 22 to FIG. 27. FIG. 22 shows input in the common screen; FIG. 23 shows the common screen for management which is displayed at the order manager terminal; FIG. 24 shows the common screen which is displayed at the worker terminal; FIG. 25 shows the common screen for corrections which is displayed at the order manager terminal; and FIG. 26 shows the common screen displayed at the user terminal.

In this embodiment, as shown in FIG. 22, the order server 2 has a common screen 200 which can be accessed from the user terminal 3.

The common screen 200 can be accessed by the order status confirmation button 201 of the design order screen from the user terminal 3. The worker terminal 4 and the order manager terminal 5 may access the common screen 200 from the search screen 202. In addition, the e-mail screen 203 may be opened from the user terminal 3, the worker terminal 4 and the order manager terminal 5, and communication information may be written therein.

The common screen 200 is displayed so as to show the manager screen shown in FIG. 23 and the correction screen shown in FIG. 25 at the order manager terminal 5; is displayed as shown in FIG. 24 at the worker terminal 4; and is displayed as shown in FIG. 26 at the user terminal 3.

The manager screen which is the common screen 200 displayed at the order manager terminal 5 shown in FIG. 23 has design order information 200a, communication information 200b, print order information 200c, status information 200d, items changeable by user 200e, and editing history 200f. Communication information 200b is entered in the editing history information 200f.

The common screen 200 displayed at the worker terminal 4 which is shown in FIG. 24 has design order information 200a, communication information 200b, complete image upload screen 200g, the communication information which is passed to the manager and the corrector 200h, and editing history information 200f. Communication information 200b is entered in the editing history information 200f. The communication information which is passed to the manager and the corrector 200h is displayed in the editing history information 200f, but it is displayed only at the order manager terminal 5 and the worker terminal 4 and not at the user terminal 3.

The corrector screen which is the common screen 200 displayed at the order manager terminal 5 which is shown in FIG. 25 has design order information 200a, communication information 200b, print order information 200c, and editing history information 200f. Communication information 200b such as requests from the user and the like are entered in the editing history information 200f.

The common screen 200 displayed at the user terminal 3 in FIG. 26 has design order information 200a, communication information 200b, and editing history information 200f.

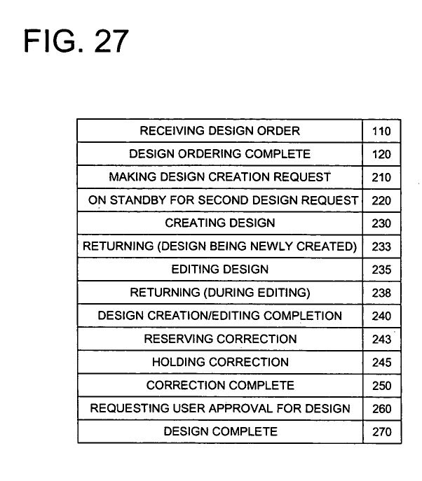

A design creation status list for the design ordering system 1 is shown in FIG. 27.

Receiving Design Order 110:

Design order information is sent from the user terminal 3, and the status is such that the design order is registered at the order server 2, and the design work cannot be distributed to the workers. Positional information for the image uploaded by the user from the user terminal 3 is undetermined. This is displayed at the manager's list of screens.

Design Ordering Complete 120:

The status is such that registering of the design order information at the order server 2 is complete, and design work can be distributed to the workers.

Making Design Creation Request 210:

After the manager distributes the design work to the workers from the order manager terminal 5, the status is such that work acceptance response from the worker is being awaited.

On Standby for Second Design Request 220:

For the orders for the design creation work that are turned down by the workers, the status is such that a second distribution of design work is being awaited.

Creating Design 230:

Workers are creating new design (first design work).

Returning (Design Being Newly Created) 233:

The status is such that during design creation, the design is returned to the manager. For example, communication information 200b describing the part of the photo image which is unclear and the way in which it is unclear is entered and returned to the manager.

Editing Design 235:

Created design is cancelled because it requires correction and the status is the editing design status.

Returning (During Editing) 238:

Editing is being done due to correction of the created design and the status is that of returning the design to the manager.

Design Creation/Editing Completion 240:

The status is such that design creation and editing is complete and correction reservation can be done.

Reserving Correction 243:

The status is such that manager or corrector has reserved correction and correction can be performed.

Holding Correction 245:

The status is such that manager or corrector who reserved the correction puts a hold on the correction work.

Correction Complete 250:

The status is such that the correction is approved and correction work is complete. The design approval request mail is not sent to the user.

Requesting User Approval for Design 260:

The status is that of awaiting user approval.

Design Complete 270:

The status is such that user approval has been received and design work is complete.

Because the order server 2 has a common screen 200 which is accessible from the user terminal 3, the order manager terminal 5, and the worker terminal 4, the user, the order manager, the worker and the corrector can all share information that changes regardless of location and time on the common screen 200 of the order server 2, and design creation, correction and the like can be performed speedily and accurately.

Because the order manager terminal 5 forms the corrector terminal, the order manager may function as the corrector.

Because the common screen comprises at least design order information 200a and communication information to be passed between the user and the manager 200b, information that changes regardless of location and time can be accurately communicated at any time. For example, when the user and the order manager attempt to communicate with regard to the design creation, sometimes-contact is not possible by phone because the party being contacted is away, or when it is not possible to accurately relate by telephone or facsimile the portion of the image that is unclear, the manner in which it is unclear, or the location for editing on the design that has been created, because the common screen 200 has at least design order information 200a and communication information to be passed between the user and the manager 200b, design creation and correction can be performed speedily and accurately.

In addition, the common screen 200 has communication information 200b which is only displayed on the manager terminal 5 and the worker terminal 4 and is not displayed on the user terminal 3, and unnecessary information is not passed to the user, and thus it is possible for the order manager and the worker to communicate and design creation and correction and the like can be formed speedily and accurately.

Because the common screen 200 displays the complete design which has been created, design editing can be performed speedily and accurately while viewing the design.

Because the common screen 200 has editing history information 200f for the created design, design creation and correction can be performed speedily and accurately without waste, based on the editing history information 200f.

This invention a design ordering system which provides the user (customer) with the service of creating a design for a postcard with a photo image, for example, via a network such as the internet.

1. A design ordering system comprising:
a user terminal connected to the network and to order design of image;
an order server connected to the network and to manage receipt of the design orders;
an order manager terminal connected to the network and to order for the design creation work based on the design order;
a worker terminal connected to the network and to create designs based on the order for the design creation work; and
a corrector terminal connected to the network and to correct the created design;
wherein the order server having a common screen which is accessible from the user terminal, the order manager terminal, the worker terminal and the corrector terminal.

2. The design ordering system of claim 1, wherein the order manager terminal forms the corrector terminal.

3. The design ordering system of claim 1, wherein the common screen having at least design order information and communication information.

4. The design ordering system of claim 1, wherein the common screen has communication information including information which cannot be browsed from the user-terminal.

5. The design ordering system of claim 1, wherein the common screen having an upload screen for displaying the created design.

6. The design ordering system of claim 1, wherein the common screen having editing history information for the created design.
